(19) United States
(12) Patent Application Publication
(10) Pub. No.: US 2023/0370836 A1
(43) Pub. Date: Nov. 16, 2023

(54) IDENTIFICATION METHOD AND APPARATUS

(71) Applicants: JT (JERSEY) LIMITED, St Helier (JE); EKIT.COM, INC., Wilmington, DE (US)

(72) Inventors: David TRAYNOR, Marblehead, MA (US); Toby GASSTON, Marblehead, MA (US); David LINDBLAD, St Clements (JE); Sylvie LEBELLEC, Vence (FR)

(21) Appl. No.: 18/146,016

(22) Filed: Dec. 23, 2022

Related U.S. Application Data
(63) Continuation of application No. PCT/US2022/028999, filed on May 12, 2022.

(51) Int. Cl. H04W 8/20; H04W 8/18

(52) U.S. Cl. CPC H04W 8/205; H04W 8/183

(57) ABSTRACT

A device is configured to communicate on a wireless communication network. The device includes an embedded Universal Integrated Circuit Card (eUICC). The eUICC includes an eUICC identifier having a plurality of characters which form a unique identification code for identifying the eUICC. The eUICC identifier includes a first field having a first subset of the plurality of characters, a second field having a second subset of the plurality of characters and a third field having a third subset of the plurality of characters. The first, second and third subsets each have one or more of the plurality of characters. The first field includes an issuer identifier for identifying an issuer of the eUICC. The second field includes an account identifier for identifying an account associated with the eUICC. The third field includes a device identifier for identifying the device.

### RELATED APPLICATION

This application is a bypass continuation of International Application No. PCT/US2022/028999, filed May 12, 2022, the contents of which is incorporated herein by reference in its entirety.

### TECHNICAL FIELD

The present disclosure relates to an identification method and apparatus. Aspects of the invention relate to a device comprising an embedded Universal Integrated Circuit Card (eUICC); an eUICC; and a method of identifying a device.

### BACKGROUND

It is known to connect a device, such as a cellular telephone or any mobile device, to a communication network. This typically requires that the identity or attributes of the device and any components therein be disclosed. A compliance or certification check may be performed to ensure that the user device is certified. The device may comprise an embedded Universal Integrated Circuit Card (eUICC). The eUICC comprises an eUICC identifier (EID) which comprises a unique code to enable identification of the eUICC, for example to manage services provided over a wireless communication network. The eUICC identifier (EID) is a 32-digit numeric value that contains four basic fields that are used for a variety of reasons. The selection of these numbers is governed by the standards bodies and the value of some of the digits must conform to these standards. The remaining digits are issuer specific, for example to define “individual” or “account” information. The issuer of the eUICC can define these parameters for any purpose as long as each eUICC identifier (EID) is unique and conforms to the standards.

The composition of a known eUICC identifier (EID) 100 is shown in FIG. 6. The eUICC identifier (EID) 100 is a thirty-two (32) digit numeric value that contains four basic fields Fn. A first field F1 identifies the issuer of the eUICC, for example in the form of an issuer identification number (IIN). The issuer identification number (IIN) comprises an industry identifier (D), a country (C) and an issuer identification (I). The first field F1 is in the form (D) (D) (C) (C) (C) (I) (I) (I) in the illustrated example. A second field F2 comprises individual/account information (X) associated with the eUICC. The second field F2 is in the form (X) (X) (X) (X) (X) (X) (X) (X) (X) (X) (X) (X) in the illustrated example. A third field F3 comprises issuer-specific information. The issuer-specific information may, for example, comprise one or more of the following: a production site (S) of the eUICC; a form factor (F) of the eUICC; and a customer code (A) to enable the issuer to identify the customer. The issuer-specific information may include a platform identification code (P) for identifying technical characteristics of the eUICC, such as hardware/software version, platform, date of manufacture, batch, or other values. The third field F3 is in the form (S) (S) (F) (F) (A) (A) (A) (A) (A) (A) in the illustrated example. A fourth field F4 provides check digits (L) to confirm the authenticity of the other fields. The fourth field F4 is in the form (L) (L) in the illustrated example. The format of each of the fields F1-F4 is governed at least in part by various international standards. The first field F1 typically consists of eight (8) digits to define the issuer identification number (IIN). The fourth field F4 typically consists of two (2) digits to define the check number. The third field F3 typically consists of ten (10) digits to define the issuer-specific information. The second field F2 typically consists of ten (10) or twelve (12) digits to define the individual/account information. The issuer has freedom regarding the form and content of at least the third field F3 subject to the requirement that the resulting eUICC identifier (EID) 100 is unique. The thirty-two (32) digits provided in the eUICC identifier (EID) 100 are used to meet industry standards and to contain issuer-specific information.

It is an aim of the present invention to address one or more of the disadvantages associated with the prior art.

### SUMMARY OF THE INVENTION

Aspects and embodiments of the invention provide a device, an embedded Universal Integrated Circuit Card (eUICC) and a method of identifying a device as claimed in the appended claims.

According to an aspect of the present invention there is provided a device configured to communicate on a wireless communication network, the device comprises an embedded Universal Integrated Circuit Card (eUICC);
wherein the eUICC comprises an eUICC identifier (EID) consisting of a plurality of characters which form a unique identification code for identifying the eUICC,
the eUICC identifier (EID) comprises a first field comprising a first subset of the plurality of characters, a second field comprising a second subset of the plurality of characters and a third field comprising a third subset of the plurality of characters; the first, second and third subsets each consisting of one or more of the plurality of characters;
the first field comprising an issuer identifier for identifying an issuer of the eUICC;
the second field comprising an account identifier for identifying an account associated with the eUICC; and
the third field comprising a device identifier for identifying the device.

The eUICC identifier (EID) is configured to deliver value in the use of the eUICC, for example to provide one or more of the following: customer identity, device identity and other numeric resources. The third field could define a device model number. By way of example, the third filed may be in the form of a European Article Number (EAN). Alternatively, or in addition, the third field may be combined with the first field and/or the second field to form a compliant ISO 7812 number. In certain embodiments, the eUICC identifier (EID) may comprise thirty-two (32) digits. The eUICC identifier (EID) may comprise or consist of up to twenty-two (22) digits. The first field may define an Issuer Identification Number (IIN).

The first field may consist of one or more field specific characters. Alternatively, or in addition, the second field may consist of one or more field specific characters. Alternatively, or in addition, the third field may consist of one or more field specific characters. The field specific characters do not form part of any of the other fields, i.e. the or each field specific character is specific to a particular field. In certain embodiments, the first, second and third fields may be independent of each other (i.e. non-overlapping). These field specific characters may be used to embody a specific schema or sets of schemas for the field usage.

The first field may consist of one or more field specific characters and/or one or more field nonspecific characters. Alternatively, or in addition, the second field may consist of one or more field specific characters and/or one or more field nonspecific characters. Alternatively, or in addition, the third field may consist of one or more field specific characters and/or one or more field nonspecific characters. The one or more field specific characters do not form part of any of the other fields, i.e. the or each field specific character is specific to a particular field. The one or more field nonspecific characters form part of one or more of the other fields. The one or more field nonspecific characters may be used in two or more fields. For example, the one or more field nonspecific characters may be used in the second field and the third field. The one or more field specific characters may comprise or consist of numeric characters and/or alphanumeric characters. The one or more field nonspecific characters may comprise or consist of numeric characters and/or alphanumeric characters.

The device identifier may consist of a plurality of characters. The device identifier may consist of one or more numeric characters and/or one or more alphanumeric characters. At least in certain embodiments, the device identifier may be composed of five (5) or more characters, ten (10) or more characters, or fifteen (15) or more characters. The device identifier may be composed of thirteen (13) characters, for example.

The device identifier may comprise or consist of a model number, a part number; a unique product code (UPC); or a national stock number (NSN) or other code that is used to uniquely identify a specific instance of a product, or a product model number for stock keeping, logistics, sale, tracking or activation purposes.

The device identifier may comprise a hardware version (specification) identifier for identifying a hardware version of the device. The device may be configured to access the device identifier to determine a hardware version of the eUICC. This may enable the device to perform a checking operation to determine that the installed eUICC is compatible. This may be appropriate to ensure that the device is compatible with the eUICC. For example, the device may undergo development or modification which is compatible with the eUICC having a particular hardware version.

The device identifier may comprise a unique identifier for uniquely identifying the device. The device identifier may comprise or consist of a unique identifier for enabling identification of a particular device. The device identifier on the eUICC may be paired with identification information stored on the device, for example when the device is activated. The device identifier and the identification information may be stored as paired information. The paired information may be stored locally on the device. The device may compare the stored paired information with the current device identifier information to detect changes. Any such changes may indicate fraudulent activity, such as counterfeiting. Alternatively, or in addition, the paired information may be stored on a remote storage device, such as a remote server. The remote storage device may be accessed to identify changes.

The provision of a unique identifier may enable interrogation of the eUICC to identify a particular device. Alternatively, or in addition, the provision of a unique identifier may enable detection of tampering or fraudulent activity by cross-referencing the device identifier with information stored on the device or one a remote server. For example, the device identifier may be cross-referenced with product information stored on the device to identify a change or modification which may indicate fraudulent activity. This may enable the incorporation of anti-counterfeiting measures within the device.

The issuer identifier may comprise or consist of an Issuer Identification Number (IIN). The IIN may be represented in any suitable format, for example including six (6) digits to comply with standards used for ICCID or Credit Card numbering formats including ISO7812.

The eUICC identifier (EID) may comprise at least one check character. The at least one check character may be generated in dependence on the device identifier. The at least one check character may be generated in dependence on the device identifier in combination with at least one of the first field and the second field.

The eUICC identifier (EID) may comprise a schema code to identify the format of the eUICC identifier (EID). The schema code may identify one of a plurality of predefined schemas.

The eUICC identifier (EID) may comprise one or more version number for indicating a version of the embedded Universal Integrated Circuit Card (eUICC). Alternatively, or in addition, the version number may indicate one more attribute of a component that is a part of the eUICC (like software version numbers, compliance to industry standards like Global Platform, compatibility), or an attribute of original configuration parameters within these components (like seed values or certificate references).

The device identifier may be a proprietary identifier. The proprietary identifier may relate to or be characteristic of a particular person (legal or natural). The proprietary identifier may relate to or be characteristic of an issuer or a customer.

According to a further aspect of the present invention there is provided an embedded Universal Integrated Circuit Card (eUICC) for installation in a device; the eUICC comprises an eUICC identifier (EID) consisting of a plurality of characters which form a unique identification code for identifying the eUICC,
the eUICC identifier (EID) comprising a first field of the characters, a second field of the characters and a third field of the characters; the first, second and third fields each consisting of one or more of the plurality of characters, wherein the first, second and third fields are independent of each other;
the first field comprising an issuer identifier (IIN) for identifying an issuer of the eUICC;
the second field comprising an account identifier for identifying an account associated with the eUICC; and
the third field comprising a device identifier for identifying the device.

The first field may consist of one or more field specific characters. Alternatively, or in addition, the second field may consist of one or more field specific characters. Alternatively, or in addition, the third field may consist of one or more field specific characters. The one or more field specific characters do not form part of any of the other fields, i.e. the or each field specific character is specific to a particular field. In certain embodiments, the first, second and third fields may be independent of each other (i.e. non-overlapping). These field specific characters may be used to embody a specific schema or sets of schemas for the field usage.

The first field may consist of one or more field specific characters and/or one or more field nonspecific characters. Alternatively, or in addition, the second field may consist of one or more field specific characters and/or one or more field nonspecific characters. Alternatively, or in addition, the third field may consist of one or more field specific characters and/or one or more field nonspecific characters. The one or more field specific characters do not form part of any of the other fields, i.e. the or each field specific character is specific to a particular field. The one or more field nonspecific characters form part of one or more of the other fields. The one or more field nonspecific characters may be used in two or more fields. For example, the one or more field nonspecific characters may be used in the second field and the third field. Alternatively, or in addition, the one or more field nonspecific characters may be used in the first field and the third field. The one or more field specific characters may comprise or consist of numeric characters and/or alphanumeric characters. The one or more field nonspecific characters may comprise or consist of numeric characters and/or alphanumeric characters.

The device identifier may comprise or consist of a model number; a part number; a unique product code (UPC); or a national stock number (NSN) or other code that is used to uniquely identify a specific instance of a product, or a product model number for stock keeping, logistics, sale, tracking or activation purposes.

The device identifier may comprise a hardware version identifier for identifying a hardware version of the device.

The device identifier may provide a unique identifier for uniquely identifying the device. The device identifier may comprise or consist of a unique identifier for enabling identification of a particular device.

The issuer identifier may comprise or consist of an Issuer Identification Number (IIN). The IIN may be represented in any suitable format, for example including six (6) digits to comply with standards used for ICCID or Credit Card numbering formats including ISO7812.

The eUICC identifier may comprise at least one check character. The at least one check character may be generated in dependence on the device identifier. The at least one check character may be generated in dependence on the device identifier in combination with at least one of the first field and the second field.

The eUICC identifier (EID) may comprise a schema code to identify the format of the eUICC identifier (EID). The schema code may identify one of a plurality of predefined schemas.

The eUICC identifier (EID) may comprise one or more version number for indicating a version of the embedded Universal Integrated Circuit Card (eUICC). Alternatively or in addition, the version number may indicate one more attribute of a component that is a part of the eUICC (such as one or more of a software version number, a compliance to industry standards like Global Platform, and compatibility), or an attribute of original configuration parameters within these components (such as a seed value(s) or a certificate reference(s)).

The device identifier may be a proprietary identifier. The proprietary identifier may relate to or be characteristic of a particular person (legal or natural). The proprietary identifier may relate to or be characteristic of an issuer or a customer.

According to a further aspect of the present invention there is provided an embedded Universal Integrated Circuit Card (eUICC) for installation in a device; the eUICC comprising an eUICC identifier (EID) consisting of a plurality of characters which form a unique identification code for identifying the eUICC, the eUICC identifier (EID) comprising a device identifier for identifying the device.

The eUICC identifier (EID) may comprise or consist of one or more field specific characters to define the device identifier.

The eUICC identifier (EID) may comprise or consist of one or more field specific characters and one or more field nonspecific characters to define the device identifier.

The eUICC identifier (EID) may comprise a field comprising an application identifier for indicating a suitability of the eUICC for use in a device having a particular type or classification. The application identifier may identify the suitability of the eUICC for use in the indicated type or classification of device.

According to an aspect of the present invention there is provided an embedded Universal Integrated Circuit Card (eUICC) for installation in a device; the eUICC comprises an eUICC identifier (EID) consisting of a plurality of characters which form a unique identification code for identifying the eUICC,
the eUICC identifier (EID) comprising a first field of the characters, a second field of the characters and a third field of the characters; the first, second and third fields each consisting of one or more of the plurality of characters, wherein the first, second and third fields are independent of each other;
the first field comprising an issuer identifier (IIN) for identifying an issuer of the eUICC;
the second field comprising an account identifier for identifying an account associated with the eUICC; and
the third field comprising an application identifier for indicating a suitability of the eUICC for use in a device having a particular type or classification.

The application identifier may identify the suitability of the eUICC for use in the indicated type or classification of device. For example, the application identifier may indicate that the eUICC is suitable for use in a device having a first classification (or a first type); and is unsuitable for use in a device having a second classification (or a second type). In use, the device may be configured to access the third field of the eUICC to determine a compatibility with the eUICC. The device may access the third field to determine that the eUICC is compatible or incompatible. A device having the first classification (or the first type) may access the third field and determine that the eUICC is compatible. A device having the second classification (or the second type) may access the third field and determine that the eUICC is incompatible. The application identifier may, for example, indicate a technical classification or a security classification of the eUICC. The device may be configured to access the application identifier to determine compatibility with the eUICC. The device may perform a compatibility check during the assembly process, on start-up or during a configuration phase.

According to a further aspect of the present invention there is provided a device comprising the eUICC described herein.

In arrangements in which the eUICC comprises an application identifier, the device may be configured to control operation of the device in dependence on the application identifier. The device may be configured to inhibit or restrict operation if the application identifier indicates that the eUICC is incompatible or is not suitable for use in the device. The device may be configured to enable operation if the application identifier indicates that the eUICC is compatible or is suitable for use in the device.

According to a further aspect of the present invention there is provided a method of identifying a device comprising an embedded Universal Integrated Circuit Card (eUICC), the eUICC comprising an eUICC identifier (EID) consisting of a plurality of characters which form a unique identification code for identifying the eUICC, the eUICC identifier (EID) comprising a device identifier for identifying the device; the method comprising accessing the embedded Universal Integrated Circuit Card (eUICC) and reading the device identifier. The method may comprise comparing the device identifier accessed from the embedded Universal Integrated Circuit Card (eUICC) with a separate device identifier stored on the device, for example in a system memory associated with the device. By way of example, the method may comprise comparing the device identifier accessed from the embedded Universal Integrated Circuit Card (eUICC) with the International Mobile Equipment Identity (IMEI).

According to a further aspect of the present invention there is provided an embedded Universal Integrated Circuit Card (eUICC) for installation in a device; the eUICC comprises an eUICC identifier (EID) consisting of a plurality of characters which form a unique identification code for identifying the eUICC;
the eUICC identifier (EID) comprising an account identifier for identifying an account associated with the eUICC, and a device identifier for identifying the device;
wherein the device identifier consists of one or more field specific characters and one or more field nonspecific characters.

Unless indicated to the contrary, or otherwise incompatible, references herein to an “issuer” are to be interpreted as referring to a person (legal or natural) that issues the eUICC. Similarly, references herein to a “customer” are to be interpreted as referring to a person (legal or natural) that receives the eUICC from the issuer (i.e. a customer of the issuer).

According to a further aspect of the present invention there is provided an embedded Universal Integrated Circuit Card (eUICC);
wherein the eUICC comprises an eUICC identifier (EID) consisting of a plurality of characters which form a unique identification code for identifying the eUICC,
the eUICC identifier (EID) comprises a first field comprising a first subset of the plurality of characters, a second field comprising a second subset of the plurality of characters and a third field comprising a third subset of the plurality of characters; the first, second and third subsets each consisting of one or more of the plurality of characters;
the first field comprising an issuer identifier (IIN) for identifying an issuer of the eUICC;
the second field comprising an account identifier for identifying an account associated with the eUICC; and
the third field comprising a schema code to identify the format of the eUICC identifier (EID). A further aspect of the present invention relates to a device comprising the embedded Universal Integrated Circuit Card (eUICC) of the type described herein.

According to a further aspect of the present invention there is provided an embedded Universal Integrated Circuit Card (eUICC) for installation in a device; the eUICC comprises an eUICC identifier (EID) consisting of a plurality of characters which form a unique identification code for identifying the eUICC,
the eUICC identifier (EID) comprising a first field of the characters, a second field of the characters and a third field of the characters; the first, second and third fields each consisting of one or more of the plurality of characters, wherein the first, second and third fields are independent of each other;
the first field comprising an issuer identifier (IIN) for identifying an issuer of the eUICC;
the second field comprising an account identifier for identifying an account associated with the eUICC; and
the third field comprising a proprietary identifier. The proprietary identifier may relate to or be characteristic of a particular person (legal or natural) or legal entity. The proprietary identifier may relate to or be characteristic of an issuer or a customer.

The eUICC may be issued by an issuer to a customer. The customer may be a person (legal or natural) that receives the eUICC from an issuer. The customer may, for example, manufacture or assemble a device in which the eUICC is installed. The proprietary identifier may have a format or composition defined by the issuer. Alternatively, the proprietary identifier may have a format or composition defined by the customer (as opposed to a format or composition defined by the issuer). The proprietary identifier may comprise or consist of a customer-defined identifier. The eUICC identifier (EID) may comprise a schema code to identify the format of the eUICC identifier (EID).

The proprietary identifier may comprise or consist of one or more field specific characters. Alternatively, or in addition, the proprietary identifier may comprise or consist of one or more field nonspecific characters. At least in certain embodiments, the proprietary identifier may comprise or consist of one or more field specific characters, and one or more field nonspecific characters. The one or more field specific characters do not form part of any of the other fields, i.e. the or each field specific character is specific to a particular field. The one or more field nonspecific characters form part of one or more of the other fields. The one or more field nonspecific characters may be used in two or more fields. For example, the one or more field nonspecific character may be used in the second field and the third field. Alternatively, or in addition, the one or more field nonspecific characters may be used in the first field and the third field. The one or more field specific characters may comprise or consist of numeric characters and/or alphanumeric characters. The one or more field nonspecific characters may comprise or consist of numeric characters and/or alphanumeric characters.

A further aspect of the present invention relates to a device comprising the embedded Universal Integrated Circuit Card (eUICC) of the type described herein. The proprietary identifier may comprise a device identifier of the type described herein for identifying the device or one or more characteristics of the device.

According to a further aspect of the present invention there is provided an embedded Universal Integrated Circuit Card (eUICC) for installation in a device; the eUICC comprises an eUICC identifier (EID) consisting of a plurality of characters which form a unique identification code for identifying the eUICC;
the eUICC identifier (EID) comprising a proprietary identifier for defining an attribute or characteristic of the eUICC and/or the device. The proprietary identifier may be relate to or be associated with a particular person (legal or natural), entity or organisation. The proprietary identifier may have a proprietary format or composition, for example defined by a customer or an issuer. The proprietary identifier may comprise or consist of a customer-defined identifier. The eUICC identifier (EID) may comprise a schema code to identify the format of the eUICC identifier (EID). The proprietary identifier may consist of one or more field specific characters and one or more field nonspecific characters.

Any control unit or controller described herein may suitably comprise a computational device having one or more electronic processors. The system may comprise a single control unit or electronic controller or alternatively different functions of the one or more controllers may be embodied in, or hosted in, different control units or controllers. As used herein the term “controller” or “control unit” will be understood to include both a single control unit or controller and a plurality of control units or controllers operating to provide any stated control functionality. To configure a controller or control unit, a suitable set of instructions may be provided which, when executed, cause the said control unit or computational device to implement the control techniques specified herein. The set of instructions may suitably be embedded in said one or more electronic processors. Alternatively, the set of instructions may be provided as software saved on one or more memories associated with the said controller to be executed on the said computational device. The control unit or controller may be implemented in software run on one or more processors. One or more other control units or controllers may be implemented in software run on one or more processors, optionally the same one or more processors as the first controller. Other suitable arrangements may also be used.

At least in certain embodiments, a portion of the functionality described herein may be implemented using storage devices, network devices, or special-purpose computer systems, in addition to or instead of being implemented using general-purpose computer systems. The term “computing device,” as used herein, refers to at least all these types of devices and is not limited to these types of devices.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a wireless communication system configured to communicate with one or more user devices in accordance with an embodiment of the present invention;

FIG. 2 shows a schematic representation of the user device configured to communicate over the wireless communication system shown in FIG. 1;

FIGS. 3A-D show the composition of the eUICC identifier (EID) in accordance with embodiments of the present invention;

FIG. 4 illustrates variants of the eUICC identifier;

FIG. 5 illustrates a plurality of different schemas for defining the fields in the eUICC identifier; and

FIG. 6 shows a known eUICC identifier in the form of a thirty-two (32) digit numeric value.

### DETAILED DESCRIPTION

A device 1 having an embedded Universal Integrated Circuit Card (eUICC) 3 in accordance with an embodiment of the present invention will now be described with reference to the accompanying figures.

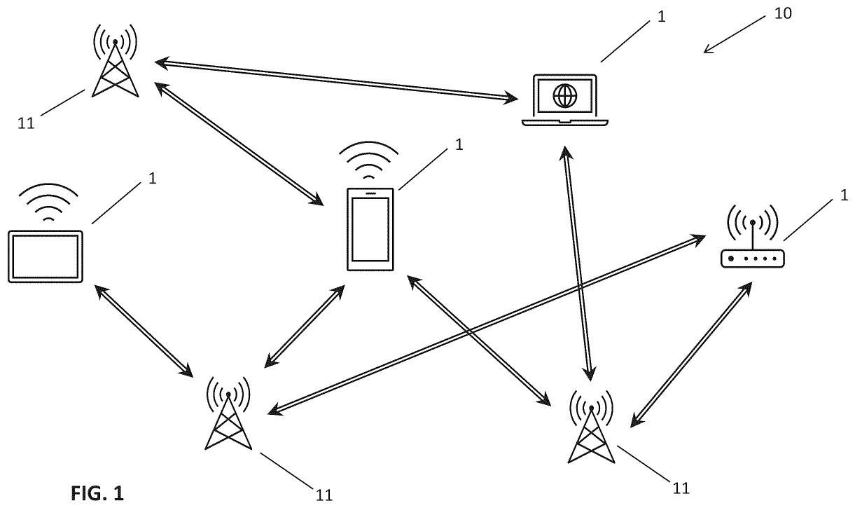

A schematic representation of a wireless communication system 10 is shown in FIG. 1. The wireless communication system 10 comprises a plurality of base stations 11 for establishing a wireless communication network. The base stations 11 are configured to communicate wirelessly with one or more devices 1. The base stations 11 each comprise an antenna (not shown) for providing communication coverage in a coverage area. The device 1 is configured to exchange data with other devices and systems over the wireless communication network. The device 1 may receive and/or send data over the wireless communication network. The device 1 in the present embodiment comprises a cellular telephone (mobile telephone). However, the present invention is not restricted to cellular telephones. The device 1 may comprise or form part of one or more of the following: a cellular enabled computing device, such as a personal computer, a laptop computer or a tablet computer; a companion device, such as a smart watch; a cellular connected appliance; a telematics device or a communications system for a vehicle, such as an automobile or an aircraft; a cellular connected utility meter; a security system; a cellular connected sensor or device; a bank card for performing financial transactions (such as a credit card or a debit card); and a component or subassembly. The device 1 may be incorporated into another device, such as an appliance, a vehicle or a computing device. The device 1 may be portable or may be in a fixed location. The device 1 may be connected to the internet, for example connected via the Internet of Things (IoT).

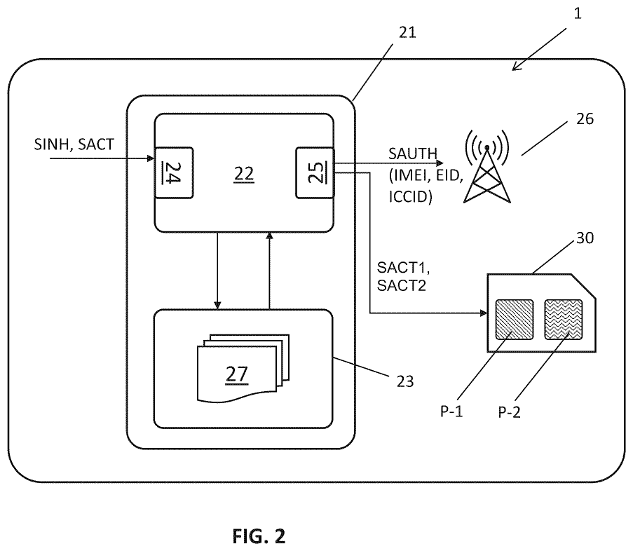

A schematic representation of the device 1 is shown in FIG. 2. The device 1 comprises a control unit 21. The control unit 21 comprises at least one electronic processor 22 and a memory device 23. The electronic processor 22 has at least one electrical input 24 and at least one electrical output 25. The electronic processor 22 is electrically connected to a device antenna 26 for wireless communication with the base stations 11. A set of computational instructions 27 is stored in the memory device 23. The computational instructions 27 are accessible by the at least one electronic processor 22. When executed, the computational instructions cause the at least one electronic processor 22 to perform the method(s) described herein.

The device 1 has a unique identifier in the form of an International Mobile Equipment Identity (IMEI). The IMEI is a unique 15-digit number assigned to each device 1. The IMEI may be used to determine information associated with the device 1, for example the manufacturer and model type. The IMEI may be combined with a software version identifier to indicate which software version (for example, which version of the operating system) is currently installed on the device 1. This combination may be referred to as an International Mobile Equipment Identity with Software Version (IMEISV). Unless indicated to the contrary, references herein to the IMEI are to be understood as also including variations, such as the IMEISV which includes a software version identifier. As described herein, the at least one electronic processor 22 is configured to acquire the IMEI associated with the device 1.

The device 1 comprises a credential device 30 for uniquely identifying the device 1. The credential device 30 may be used to identify an account or subscription associated with the device 1 to control access to subscription services provided by a service provider. As described herein, the credential device 30 comprises one or more credentials which enable the device 1 to be uniquely identified. The sole credential or each credential may comprise a globally unique value which may, for example, be numerical or alphanumerical. The credential device 30 in the present embodiment comprises an embedded Universal Integrated Circuit Card (eUICC 3). The eUICC 3 enables changes to the service provider to be made over-the-air (OTA) without the need physically to change the eUICC 3. The eUICC 3 may be removable from the device 1. Alternatively, the eUICC 3 may be non-removable from the device 1, for example in the form of a soldered eUICC 3. The eUICC 3 can be provided in various form factors, for example the eUICC 3 may be provided in the form of a SIM card. Other types of credential device 30 are contemplated, such as a Universal Integrated Circuit Card (UICC) or a Subscriber Identity Module (SIM) card. The eUICC 3 can be identified by a globally unique value in the form of an eUICC identifier (eUICC 3-ID or EID). The eUICC identifier (EID) is stored on the eUICC 3, for example in read only memory. The format of the eUICC identifier (EID) will now be described with reference to the accompanying figures.

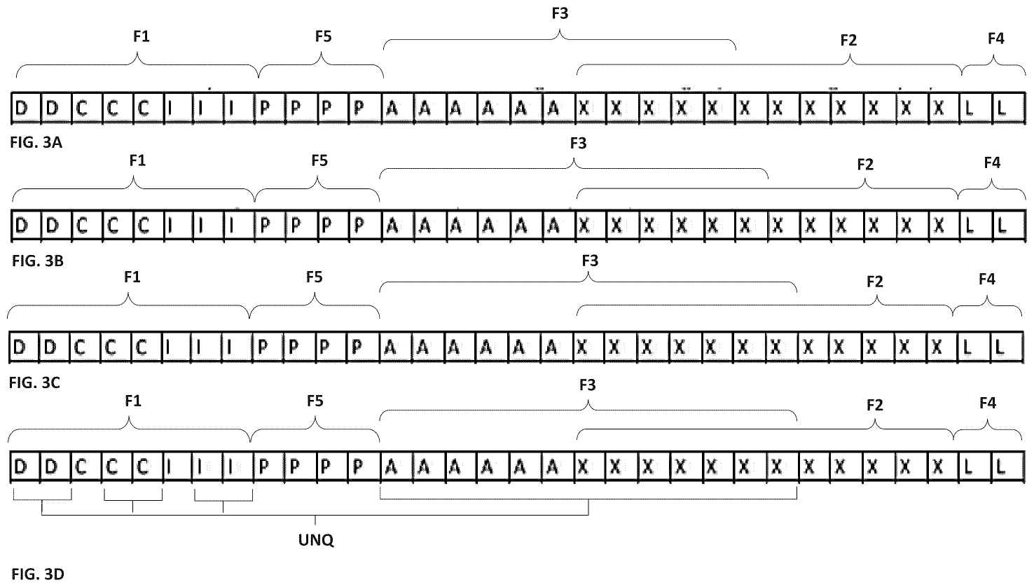

The composition of the eUICC identifier (EID) in accordance with embodiments of the present invention is illustrated in FIGS. 3A-D. The eUICC identifier (EID) comprises a plurality of characters. In certain embodiments, the characters may be numerical, i.e. each consisting of a numerical values representing a whole number. In the present embodiment, the characters are alphanumeric consisting of letters and numbers. Alternatively, or in addition, the alphanumeric characters may comprise symbols. The eUICC identifier (EID) is a thirty-two (32) digit alphanumeric value that contains five (5) fields Fn. The eUICC identifier (EID) in the present embodiment comprises a first field F1, a second field F2, a third field F3, a fourth field F4 and a fifth field F5. The eUICC identifier (EID) may comprise less than or more than five (5) fields F1-F5. The first, second, third, fourth and fifth fields F1-F5 each comprise a subset of the characters of the eUICC identifier (EID). Each subset may consist of one or more characters of the eUICC identifier (EID). The character(s) in each field F1-F5 are preferably grouped together to form contiguous blocks, but this is not essential. In the present embodiment, the first, second, third, fourth and fifth fields F1-F5 are independent of each other, i.e. there is no overlap between the first, second, third, fourth and fifth fields F1-F5. Thus, each character making up the eUICC identifier (EID) is present in only one of the first, second, third, fourth and fifth fields F1-F5. In a variant, there may be an overlap between two or more of the first, second, third, fourth and fifth fields F1-F5. For example, some of the characters making up the second field F2 may also be used in the third field F3. By way of example, one or more of the most significant numbers in the second field F2 may be incorporated into the third field F3. The composition of each of the first, second, third, fourth and fifth fields F1-F5 will now be described.

The first field F1 identifies the issuer of the eUICC 3, for example in the form of an issuer identification number (IIN). The issuer identification number (IIN) comprises at least one digit representing each of the following: an industry identifier (D), a country (C) and an issuer identification (I). The second field F2 comprises at least one digit representing an individual/account information (X) associated with the eUICC 3. The third field F3 differs from the arrangement described herein with reference to the known eUICC identifier (EID). In the present embodiment, the third field F3 comprises at least one digit representing customer information (A). The fourth field F4 comprises at least one digit representing a check digit (L) to confirm the authenticity of one or more of the other fields. The fifth field F5 comprises at least one digit representing issuer-specific information. The issuer-specific information comprises one or more of the following: a production site code (S); and a form factor code (F). Alternatively, or in addition, the fifth field F5 may comprise platform information (P), for example to indicate a version or a platform of the eUICC 3.

The composition of each of the fields F1-F5 in the present embodiment will now be described. The first field F1 consists of eight (8) digits to define the issuer identification number (IIN). The first field F1 is in the form (D) (D) (C) (C) (C) (I) (I) (I). The second field F2 consists of ten (10) or twelve (12) digits. The second field F2 is in the form (X) (X) (X) (X) (X) (X) (X) (X) (X) (X) (X) (X). The fifth field F5 consists of four (4) digits. The third field F3 consists of ten (10) digits. The third field F3 is in the form (A) (A) (A) (A) (A) (A). The fourth field F4 consists of two (2) digits. The fourth field F4 is in the form (L) (L). The fifth field F5 is in the form (S) (S) (F) (F). It will be understood that the number of digits in each of the fields F1-F5 may be increased or decreased. Furthermore, one or more of the fields F1-F5 may be omitted in certain embodiments.

The customer information (A) defined in the third field F3 relates to the intended use or application of the eUICC 3. The customer information (A) may, for example, establish a relationship between the eUICC 3 and the device 1 in which the eUICC 3 will be installed. The customer information (A) may thereby facilitate tracking and/or handling of the eUICC 3 by the customer. By way of example, the customer information (A) may comprise or consist of a device identifier for identifying the device 1 in which the eUICC 3 will be installed. The device identifier may identify a type or a model of the device in which the eUICC 3 will be installed. By way of example, the device identifier may comprise a part number; a unique product code (UPC); or a national stock number (NSN). The device identifier may facilitate the tracking and/or handling of the eUICC 3 during assembly of the device 1. During assembly of the device 1, the device identifier may be accessed directly from the eUICC 3.

The device identifier provided on the eUICC 3 may associate the eUICC 3 with the device 1. The association between the eUICC 3 and the device 1 may be used subsequently to identify tampering or modifications to the device 1. For example, if the eUICC 3 is replaced with a non-standard item, this may be identified with reference to the device identifier incorporated into the eUICC identifier (EID) and a unique identifier stored on the device 1. The device 1 may comprise a unique identifier in the form of an International Mobile Equipment Identity (IMEI) or an International Mobile Equipment Identity with Software Version (IMEISV). Unless indicated to the contrary, references herein to the IMEI are to be understood as also including variations, such as the IMEISV which includes a software version identifier. The device identifier incorporated into the eUICC identifier (EID) may be cross-referenced with the unique identifier stored on the device 1 to identify changes or modifications. Any discrepancy may indicate tampering or modification of the device 1. In use, a service provider may access the information stored on the device 1 and the eUICC 3 to check for discrepancies.

The at least one check digit (L) provided in the fourth field F4 is generated by application of a suitable check digit generating algorithm to one or more of the first field F1, the third field F3, the second field F2 and the fifth field F5. The algorithm generates the at least one check digit (L) when the eUICC identifier (EID) is generated. By applying the same algorithm, the one or more check digit (L) enables determination of the accuracy or authenticity of the eUICC identifier (EID). In the present embodiment, the at least one check digit (L) is generated in dependence on at least the third field F3 comprising the customer information.

The first, second, third, fourth and fifth fields F1-F5 in the above arrangement are independent of each other. Each field F1-F5 comprises one or more field specific characters in the eUICC identifier (EID). The field specific characters are each used in respect of only one of the fields F1-F5. By way of example, the one or more characters making up the third field F3 are not present in any of the other fields. In a variant, there may be an overlap between two or more of the first, second, third, fourth and fifth fields F1-F5. One or more of the fields F1-F5 may comprise one or more field nonspecific characters in the eUICC identifier (EID). The one or more field nonspecific characters may be used in combination with one or more field specific characters. By way of example, one or more of the characters making up the second field F2 may also be used in the third field F3. The third field F3 in the illustrated arrangement comprises a device identifier composed of a plurality of field specific characters in combination with one or more field nonspecific characters. The field specific characters are dedicated characters which are specific to a particular field (i.e., are not used in any of the other fields). The field specific characters may, for example, comprise or consist of one or more of the characters defining the customer information (A). Conversely, the field nonspecific characters are used in two or more of the fields. The field nonspecific characters may, for example, be used in the third field F3 to define at least a portion of the customer information (A) and also in the second field F2 to define at least a portion of the individual/account information (X). The field nonspecific characters in this arrangement may, for example, consist of one or more of the most significant digits of the individual/account information (X). The field specific characters and the field nonspecific characters are preferably defined adjacent to each other within the eUICC identifier (EID) such that the device identifier is a contiguous block of characters. The sequence of the field specific characters and the field nonspecific characters within the eUICC identifier (EID) may be reversed.

A first embodiment utilising a combination of field specific characters and field nonspecific characters to define the third field F3 is illustrated in FIG. 3A. The third field F3 in this embodiment consists of a device identifier, for example to identify a device 1 used in the assembly of an automobile. The device identifier is composed of a plurality of field specific characters and a plurality of field nonspecific characters. The field specific characters consist of a plurality of characters defining the customer information (A). The field nonspecific characters comprise a portion of the unique individual/account information (X). In this example, the device identifier consists of six (6) field specific characters; and five (5) field nonspecific characters. The resulting device identifier is composed of eleven (11) digits. This may, for example, correspond to nine (9) characters with one of the characters being alphanumeric. Other combinations of numeric and alphanumeric characters are also contemplated. The fifth field F5 comprises issuer-specific information comprises a platform identification code (P) for identifying technical characteristics of the eUICC 3.

A second embodiment utilising a combination of field specific characters and field nonspecific characters to define the third field F3 is illustrated in FIG. 3B. The third field F3 in this embodiment consists of a device identifier, for example to identify a device 1 comprising a Subscriber Identity Module (SIM). The device identifier is composed of a plurality of field specific characters and a plurality of field nonspecific characters. The field specific characters consist of a plurality of characters defining the customer information (A). The field nonspecific characters comprise a portion of the unique individual/account information (X). In this example, the device identifier consists of six (6) field specific characters; and six (6) field nonspecific characters. The resulting device identifier is composed of twelve (12) digits. This may, for example, correspond to twelve (12) characters to define a unique product code (UPC) for a product comprising the SIM. Other combinations of numeric and alphanumeric characters are also contemplated. The fifth field F5 comprises issuer-specific information comprises a platform identification code (P) for identifying technical characteristics of the eUICC 3.

A third embodiment utilising a combination of field specific characters and field nonspecific characters to define the third field F3 is illustrated in FIG. 3C. The third field F3 in this embodiment consists of a device identifier, for example to identify a device 1, such as a sensor, used in the assembly of an aircraft. The device identifier in this arrangement may comprise a national stock number (NSN). The NSN in this example is a 13-digit number to comply with NATO requirements. The device identifier is composed of a plurality of field specific characters and a plurality of field nonspecific characters. The field specific characters consist of a plurality of characters defining the customer information (A). The field nonspecific characters comprise a portion of the unique individual/account information (X). In this example, the device identifier consists of six (6) field specific characters; and seven (7) field nonspecific characters. The resulting device identifier is composed of thirteen (13) characters. This may, for example, correspond to thirteen (13) digits of the NSN. Other combinations of numeric and/or alphanumeric characters are also contemplated. The fifth field F5 comprises issuer-specific information comprises a platform identification code (P) for identifying technical characteristics of the eUICC 3.

A fourth embodiment utilising a combination of field specific characters and field nonspecific characters to define the third field F3 is illustrated in FIG. 3D. The third field F3 in this embodiment consists of a valid number for identifying a card for performing financial transactions, such as a credit card or a debit card. The number may be ISO 7812 compliant and may be independent of the eUICC identifier (EID). The device 1 in this example may be in the form of a card issued by a financial organisation. The device identifier in this arrangement may, for example, comprise a credit card number (UNQ). The device identifier is composed of a plurality of field specific characters and a plurality of field nonspecific characters (D), (C), (I), (X). In this example, the device identifier consists of six (6) field specific characters; and thirteen (13) field nonspecific characters (D), (C), (I), (X). The field specific characters consist of a plurality of characters defining the customer information (A). The field nonspecific characters in this example include the industry identifier (D), the country identifier (C), the issuer identifier (I) and a part of the unique individual/account information (X). Other combinations of numeric and alphanumeric characters are also contemplated. The fifth field F5 comprises issuer-specific information such as a platform identification code (P) for identifying technical characteristics of the eUICC 3.

By employing a combination of field specific characters and one or more field nonspecific characters, additional characters may be made available to define the device identifier without increasing the total number of characters making up the eUICC identifier (EID). This may facilitate processing of the eUICC identifier (EID), for example reducing storage requirements. It will be understood that this approach may be used to define other fields and is not limited to defining the device identifier. It is believed that this methodology is patentable independently.

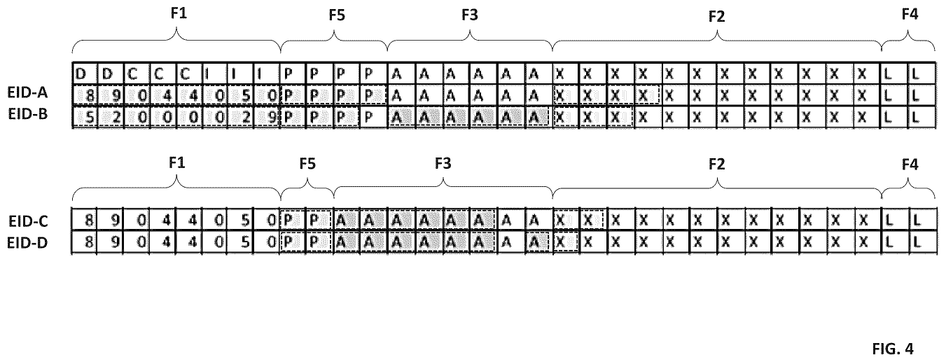

Further variants of the composition of the fields F1-F5 within the eUICC identifier (EID) are illustrated in FIG. 4. A first variant EID-A forms the third field F3 from a combination of field specific characters and field nonspecific characters. The field specific characters consist of six (6) characters defining the customer information (A); and the field nonspecific characters consist of the initial four (4) characters of the unique individual/account information (X). The field specific characters and the field nonspecific characters form a contiguous block within the eUICC identifier (EID). A second variant EID-B forms the third field F3 from a combination of field specific characters and field nonspecific characters. The field specific characters consist of six (6) characters defining the customer information (A); and the field nonspecific characters consist of the initial three (3) characters of the unique individual/account information (X). The field specific characters and the field nonspecific characters form a contiguous block within the eUICC identifier (EID). A third variant EID-C forms the third field F3 from a combination of field specific characters and field nonspecific characters. The field specific characters consist of six (6) characters defining the customer information (A); and the field nonspecific characters consist of the initial two (2) characters of the unique individual/account information (X). The field specific characters and the field nonspecific characters form two blocks which are separated from each other within the eUICC identifier (EID). A fourth variant EID-D forms the third field F3 from a combination of field specific characters and one field nonspecific character. The field specific characters consist of six (6) characters defining the customer information (A); and the field nonspecific character is the initial one (1) character of the unique individual/account information (X). The field specific characters and the field nonspecific character form two blocks which are separated from each other within the eUICC identifier (EID). In the fourth variant EID-D, one of the characters defining the customer information (A) is used to indicate that a predefined selection of characters within the eUICC identifier (EID) may be used form an ISO 7812 compliant card number (UNQ) independent of the eUICC identifier (EID). The arrangement illustrated by the fourth variant D may be employed in the fourth example detailed above.

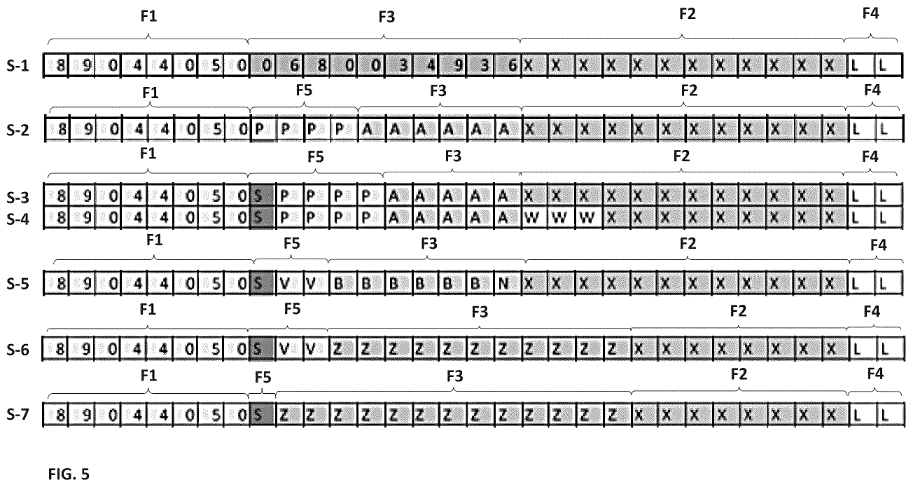

It will be understood that various configurations of the fields F1-F5 may be defined within the eUICC identifier (EID). A series of different schemas S-n are illustrated in FIG. 5. The schemas S-n are now described in more detail.

A first schema S-1 represents the arrangement described herein in which the third field F3 comprises ten (10) field-specific characters representing customer information (A).

A second schema S-2 represents the arrangement described herein in which the third field F3 comprises six (6) field-specific characters representing customer information (A). The fifth field F5 comprises four (4) characters representing platform information (P), for example to indicate one or more of the following: a hardware version, a software version, and a platform version. The platform information (P) in the present embodiment defines one or more property of the eUICC3.

A third schema S-3 represents an arrangement in which the third field F3 comprises five (5) field-specific characters representing customer information (A). The fifth field F5 comprises four (4) characters representing platform information (P). The platform information (P) may indicate one or more of the following: a hardware version, a software version, and a platform version. The platform information (P) in the present embodiment defines one or more property of the eUICC3. In addition, the third schema S-3 comprises a schema identifier (S) which identifies the schema employed in the eUICC identifier (EID). The schema identifier (S) is illustrated as forming part of the fifth field F5, but may be a separate field or may be incorporated into one of the other fields.

A fourth schema S-4 represents an arrangement in which the third field F3 comprises five (5) field-specific characters representing customer information (A); and the fifth field F5 comprises four (4) characters representing platform information (P). The platform information (P) may indicate one or more of the following: a hardware version, a software version, and a platform version. The platform information (P) in the present embodiment defines one or more property of the eUICC3. The fourth schema S-4 comprises a schema identifier (S) which identifies the schema employed in the eUICC identifier (EID). The schema identifier (S) is illustrated as forming part of the fifth field F5, but may be a separate field or may be incorporated into one of the other fields. Furthermore, the fourth schema S-4 comprises one or more customer control identifiers (W) which may be defined by a customer.

A fifth schema S-5 represents an arrangement in which the third field F3 comprises six (6) field-specific characters representing a customer code (B) allocated for each customer or customer issuer identification number (IIN) or a GS1 product identification core. The fifth field F5 comprises two (2) characters representing a version (V) indicating a version or platform. A schema identifier (S) identifies the schema employed in the eUICC identifier (EID). The schema identifier (S) is illustrated as forming part of the fifth field F5, but may be a separate field or may be incorporated into one of the other fields. The fifth schema S-5 may optionally comprise one or more customer control identifier (W). The customer control identifier (W) may be defined by a customer or may be used to partition the fields. The fifth schema S-5 may be used to define a valid number for identifying a card for performing financial transactions. The number defined within the eUICC identifier (EID) may be ISO 7812 compliant. An identifier (N) may be incorporated into the fifth schema S-5 to indicate that the number is encoded within the eUICC identifier (EID).

A sixth schema S-6 represents an arrangement in which the third field F3 comprises thirteen (13) field-specific characters representing customer information in the form of a code (Z). The code (Z) may be specified by the customer. A schema identifier (S) identifies the schema employed in the eUICC identifier (EID). The schema identifier (S) is illustrated as forming part of the fifth field F5, but may be a separate field or may be incorporated into one of the other fields. The fifth field F5 comprises two (2) characters representing a version (V) indicating a version or platform. A schema identifier (S) identifies the schema employed in the eUICC identifier (EID).

A seventh schema S-7 represents an arrangement in which the third field F3 comprises fifteen (15) field-specific characters representing customer information in the form of a code (Z). The code (Z) may be specified by the customer. A schema identifier (S) identifies the schema employed in the eUICC identifier (EID). The schema identifier (S) is illustrated as forming part of the fifth field F5, but may be a separate field or may be incorporated into one of the other fields.

The embodiment described herein describes the arrangement in which the customer information (A) comprises a device identifier for identifying the device 1 in which the eUICC 3 is installed. Other identifiers are also contemplated in the eUICC identifier (EID). For example, a proprietary identifier may be defined within the eUICC identifier (EID). The proprietary identifier may relate to or be characteristic of a particular person (legal or natural) or legal entity. The proprietary identifier may relate to or be characteristic of the issuer or the customer. The proprietary identifier may have a format or composition defined by the issuer. Alternatively, the proprietary identifier may have a format or composition defined by the customer. The proprietary identifier may comprise or consist of a customer-defined identifier.

It will be appreciated that various changes and modifications can be made to the present invention without departing from the scope of the present application.

### FIG. 5—KEY

| | | |
|---|---|---|
| B | CLIENT CODE | Identifier allocated for each Client, |
| | | Client Issuer Identifier (IIN), |
| | | GS1 or Partition Information |
| W | CLIENT CONTROL | Allows client control of digits |
| | | or partitioning of the ranges |
| P | PLATFORM | Version and/or platform identifier |
| A | CLIENT DESCRIPTION | Client type and/or location identifier |
| V | VERSION | Version and/or platform identifier |
| S | SCHEMA | EID Schema identifier |
| Z | FREE FORM | Customer defined code |

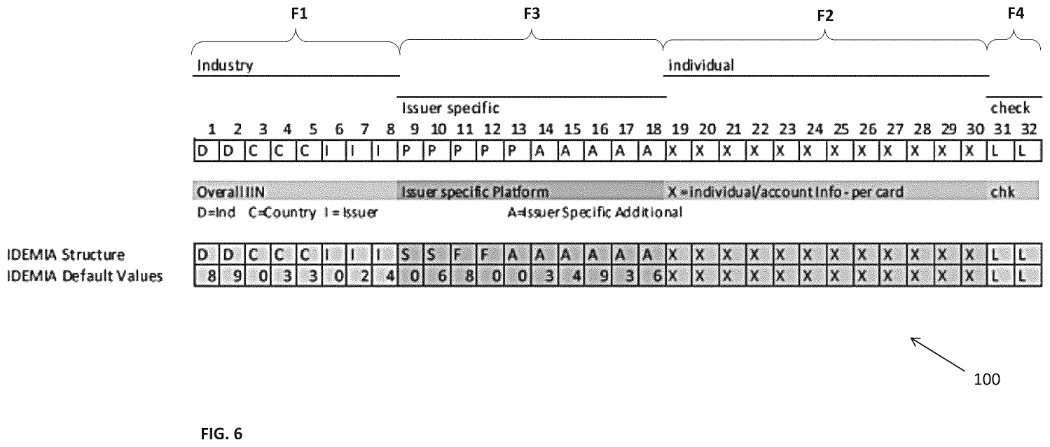

### FIG. 6—KEY

| | |
|---|---|
| A | CUSTOMER CODE |
| F | FORM FACTOR |
| S | PRODUCTION SITE |
| C | COUNTRY (IN ISSUER IDENTIFIER (IID)) |
| I | ISSUER (IN ISSUER IDENTIFIER (IID)) |
| D | INDUSTRY (IN ISSUER IDENTIFIER (IID)) |

1. A device configured to communicate on a wireless communication network, the device comprises an embedded Universal Integrated Circuit Card (eUICC);
wherein the eUICC comprises an eUICC identifier consisting of a plurality of characters which form a unique identification code for identifying the eUICC,
the eUICC identifier comprises a first field comprising a first subset of the plurality of characters, a second field comprising a second subset of the plurality of characters and a third field comprising a third subset of the plurality of characters; the first, second and third subsets each consisting of one or more of the plurality of characters;
the first field comprising an issuer identifier for identifying an issuer of the eUICC;
the second field comprising an account identifier for identifying an account associated with the eUICC; and
the third field comprising a device identifier for identifying the device.

2. A device as claimed in claim 1, wherein the third field consists of one or more field specific characters.

3. A device as claimed in claim 1, wherein the third field consists of one or more field specific characters and one or more field nonspecific characters.

4. A device as claimed in claim 1, wherein the device identifier comprises a model number; a part number; a unique product code; or a national stock number.

5.-11. (canceled)

12. An embedded Universal Integrated Circuit Card (eUICC) for installation in a device; the eUICC comprises an eUICC identifier consisting of a plurality of characters which form a unique identification code for identifying the eUICC,
the eUICC identifier comprising a first field of the characters, a second field of the characters and a third field of the characters; the first, second and third fields each consisting of one or more of the plurality of characters, wherein the first, second and third fields are independent of each other;
the first field comprising an issuer identifier for identifying an issuer of the eUICC;
the second field comprising an account identifier for identifying an account associated with the eUICC; and
the third field comprising a device identifier for identifying the device.

13. An embedded Universal Integrated Circuit Card (eUICC) as claimed in claim 12, wherein the third field consists of one or more field specific characters.

14. An embedded Universal Integrated Circuit Card (eUICC) as claimed in claim 12, wherein the third field consists of one or more field specific characters and one or more field nonspecific characters.

15. An embedded Universal Integrated Circuit Card (eUICC) as claimed in claim 12, wherein the device identifier comprises a model number; a part number; a unique product code; or a national stock number.

16.-22. (canceled)

23. An embedded Universal Integrated Circuit Card (eUICC) for installation in a device; the eUICC comprising an eUICC identifier consisting of a plurality of characters which form a unique identification code for identifying the eUICC, the eUICC identifier comprising a device identifier for identifying the device.

24. An embedded Universal Integrated Circuit Card (eUICC) as claimed in claim 23, wherein the device identifier consists of one or more field specific characters.

25. An embedded Universal Integrated Circuit Card (eUICC) as claimed in claim 23, wherein the device identifier consists of one or more field specific characters and one or more field nonspecific characters.

26. A device comprising the eUICC claimed in claim 23.

27. A method of identifying a device comprising an embedded Universal Integrated Circuit Card (eUICC), the eUICC comprising an eUICC identifier consisting of a plurality of characters which form a unique identification code for identifying the eUICC, the eUICC identifier comprising a device identifier for identifying the device; the method comprising accessing the embedded Universal Integrated Circuit Card (eUICC) and reading the device identifier.
